(19) United States
(12) Patent Application Publication
(10) Pub. No.: US 2025/0125474 A1
(43) Pub. Date: Apr. 17, 2025

(54) BATTERY MOUNTING STRUCTURE, OUTDOOR MOBILE POWER SUPPLY AND ELECTRONIC ASSEMBLY

(71) Applicant: Shenzhen Gaojing Technology Co., Ltd., Shenzhen (CN)

(72) Inventors: Zhuowen LIAO, Shenzhen (CN); Shipei LIN, Shenzhen (CN); Long MIAO, Shenzhen (CN)

(21) Appl. No.: 18/648,453

(22) Filed: Apr. 28, 2024

Related U.S. Application Data
(63) Continuation of application No. PCT/CN2023/127987, filed on Oct. 30, 2023.

(30) Foreign Application Priority Data
Oct. 13, 2023 (CN) 202311330625.X

(51) Int. Cl. H01M 50/269; H01M 50/244; H01M 50/51

(52) U.S. Cl. CPC H01M 50/269; H01M 50/244; H01M 50/51

(57) ABSTRACT

The disclosure discloses a battery mounting structure, an outdoor mobile power supply and an electronic assembly, and belongs to the technical field of electronic assemblies. The battery mounting structure comprises a telescopic member, a first battery assembly and at least one second battery assembly. The first battery assembly is sleeved on the telescopic member; one second battery assembly is sleeved on the telescopic member and electrically connected with the first battery assembly, and the remaining second battery assemblies are sleeved on the telescopic member in an axial direction of the telescopic member in sequence and electrically connected in sequence. According to the battery mounting structure provided by the disclosure, a user can increase or reduce a number of the second battery assemblies at will according to an actual electricity demand, so as to increase or reduce a battery capacity at will, thus improving use convenience and portability.

### CROSS-REFERENCE TO RELATED APPLICATION

The present disclosure claims the priority of the Chinese patent application filed on Oct. 13, 2023 to the China National Intellectual Property Administration with the application number of 202311330625.X, and the title of “BATTERY MOUNTING STRUCTURE, OUTDOOR MOBILE POWER SUPPLY AND ELECTRONIC ASSEMBLY”, which is incorporated herein in its entirety by reference.

### TECHNICAL FIELD

The present disclosure relates to the technical field of electronic assemblies, and particularly to a battery mounting structure, an outdoor mobile power supply and an electronic assembly.

### BACKGROUND OF THE PRESENT INVENTION

Outdoor mobile power supply is a special portable mobile power supply, which is mainly used for power supply in outdoor environment, wherein a large-capacity battery is usually used as an energy source, which may provide power for various outdoor devices, such as camping lamps, mobile phones, tablets, cameras, unmanned aerial vehicles, GPS and speakers.

The outdoor mobile power supply is mostly used in outdoor travel and various mobile devices, so that a large capacity is needed compared with a conventional mobile power supply. Therefore, there are more cells in a single battery, which means that a weight of the outdoor mobile power supply is heavier than that of the conventional mobile power supply.

However, a number of internal batteries in most existing outdoor mobile power supplies is fixed, so that users cannot increase or reduce a number of batteries at will according to an actual electricity demand, leading to the problem of being inconvenient to use and carry.

### SUMMARY OF THE PRESENT INVENTION

In view of this, the present disclosure is intended to overcome the defects in the prior art and to provide a battery mounting structure.

In order to solve the above technical problem, the present disclosure provides:
a battery mounting structure, which comprises:
a telescopic member;
a first battery assembly, wherein the first battery assembly is sleeved on the telescopic member; and
at least one second battery assembly, wherein one second battery assembly is sleeved on the telescopic member and electrically connected with the first battery assembly, and the remaining second battery assemblies are sleeved on the telescopic member in an axial direction of the telescopic member in sequence and electrically connected in sequence.

In addition, the battery mounting structure according to the present disclosure may also have the following additional technical features.

In some embodiments of the present disclosure, the battery mounting structure further comprises a supporting member, the first battery assembly is arranged on the supporting member, and a part of the telescopic member is located in an inner circumferential direction of the supporting member.

In some embodiments of the present disclosure, the battery mounting structure further comprises a base, and the supporting member and the telescopic member are both arranged on the base.

In some embodiments of the present disclosure, one end of the first battery assembly close to the second battery assembly is provided with a first conductive portion, one second battery assembly is sleeved on the telescopic member and electrically connected with the first conductive portion, and the remaining second battery assemblies are sleeved on the telescopic member in the axial direction of the telescopic member in sequence and electrically connected in sequence.

In some embodiments of the present disclosure, the second battery assembly is provided with a second conductive portion and a third conductive portion, the second conductive portion and the third conductive portion are respectively arranged at two ends of the second battery assembly, a second conductive portion of one second battery assembly is electrically connected with the first conductive portion, and a third conductive portion of one second battery assembly is electrically connected with a second conductive portion of an adjacent second battery assembly.

In some embodiments of the present disclosure, the first battery assembly comprises a first shell, a first battery and a circuit board, the first battery and the circuit board are both arranged in the first shell, and the first battery is electrically connected with the circuit board and the first conductive portion respectively.

In some embodiments of the present disclosure, the circuit board is provided with a charging interface and a power button, and the first shell is provided with a first avoidance port matched with the charging interface and a second avoidance port matched with the power button.

In some embodiments of the present disclosure, the second battery assembly comprises a second shell and a second battery, and the second battery is arranged in the second shell, and electrically connected with the second conductive portion and the third conductive portion respectively.

In a second aspect, the present disclosure further provides an outdoor mobile power supply, which comprises the battery mounting structure in any one of the above embodiments.

In a third aspect, the present disclosure further provides an electronic assembly, which comprises an electronic device and the outdoor mobile power supply in the above embodiment.

Compared with the prior art, the present disclosure has the beneficial effects as follows.

The present disclosure provides the battery mounting structure, and the battery mounting structure comprises the telescopic member, the first battery assembly and the at least one second battery assembly. By sleeving the first battery assembly on the telescopic member, a function of stably mounting the first battery assembly is realized. By sleeving one second battery assembly on the telescopic member and electrically connecting the second battery assembly with the first battery assembly, and sleeving the remaining second battery assemblies on the telescopic member in the axial direction of the telescopic member in sequence and electrically connecting the second battery assemblies in sequence, a user can increase or reduce a number of the second battery assemblies at will according to an actual electricity demand, so as to increase or reduce a battery capacity at will, thus improving use convenience and portability. The technical problem of being inconvenient to use and carry caused by a fact that a number of internal batteries in most existing outdoor mobile power supplies is fixed, so that the user cannot increase or reduce a number of batteries at will according to an actual electricity demand in the prior art are avoided.

### DESCRIPTION OF THE DRAWINGS

In order to illustrate technical solutions in embodiments of the present disclosure more clearly, the drawings which need to be used in the embodiments will be briefly introduced hereinafter. It is to be understood that the following drawings only show some embodiments of the present disclosure, so that the drawings should not be regarded as limiting the scope. Those of ordinary skills in the art may further obtain other related drawings according to these drawings without going through any creative work.

FIG. 1 is a stereoscopic diagram of a battery mounting structure in some embodiments of the present disclosure;

FIG. 2 is a stereoscopic diagram of the battery mounting structure in FIG. 1 without a first battery assembly;

FIG. 3 is a stereoscopic diagram of the first battery assembly in some embodiments of the present disclosure;

FIG. 4 is a stereoscopic diagram of the first battery assembly in FIG. 3 without a first shell; and

FIG. 5 is a stereoscopic diagram of an electronic assembly in some embodiments of the present disclosure.

Reference numerals of major elements:
100 refers to battery mounting structure; 110 refers to telescopic member; 120 refers to first battery assembly; 121 refers to first conductive portion; 122 refers to first shell; 1221 refers to first avoidance port; 1222 refers to second avoidance port; 123 refers to first battery; 124 refers to circuit board; 1241 refers to charging interface; 1242 refers to power button; 130 refers to supporting member; 140 refers to base; 1000 refers to outdoor mobile power supply; 10000 refers to electronic assembly; and 2000 refers to electronic device.

### DETAILED DESCRIPTION OF PREFERRED EMBODIMENTS

Embodiments of the present disclosure are described hereinafter in detail, and illustrations of the embodiments are shown in the accompanying drawings, where identical or similar reference numerals denote identical or similar elements or elements having the same or similar functions. The embodiments described hereinafter with reference to the accompanying drawings are exemplary, and are only intended to explain the present disclosure, but should not be understood as limiting the present disclosure.

In the description of the present disclosure, it should be understood that the orientation or position relationship indicated by the terms “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise”, “counterclockwise”, “axial”, “radial”, “circumferential”, and the like is based on the orientation or position relationship shown in the drawings, it is only for the convenience of description of the present disclosure and simplification of the description, and it is not to indicate or imply that the indicated device or element must have a specific orientation, and be constructed and operated in a specific orientation. Therefore, the terms should not be understood as limiting the present disclosure.

Moreover, the terms “first” and “second” are only used for descriptive purposes, but cannot be understood as indicating or implying relative importance, or implicitly indicating the number of indicated technical features. Therefore, the feature defined by “first” and “second” may explicitly or implicitly include one or more of the features. In the description of the present disclosure, the meaning of “multiple” refers to being two or more than two, unless otherwise specifically defined.

In the present disclosure, the terms “mounting”, “connected”, “connection”, “fixation”, and the like should be understood in broad sense unless otherwise specified and defined. For example, they may be fixed connection, removable connection or integrated connection; may be mechanical connection or electrical connection; and may be direct connection, or indirect connection through an intermediate medium, and connection inside two components, or interaction relation of two elements. The specific meanings of the above terms in the present disclosure may be understood in a specific case by those of ordinary skills in the art.

In the present disclosure, unless otherwise specified and limited, the first feature “on” or “under” the second feature may be direct contact between the first feature and the second feature, and may also be indirect contact between the first feature and the second feature through an intermediate medium. Furthermore, the first feature “on”, “above” and “over” the second feature refers to that the first feature is directly above and obliquely above the second feature, or only indicates that the first feature is higher than the second feature in a horizontal height. The first feature “under”, “below” and “underneath” the second feature may refer to that the first feature is directly below and obliquely below the second feature, or only indicates that the first feature is lower than the second feature in a horizontal height.

### First Embodiment

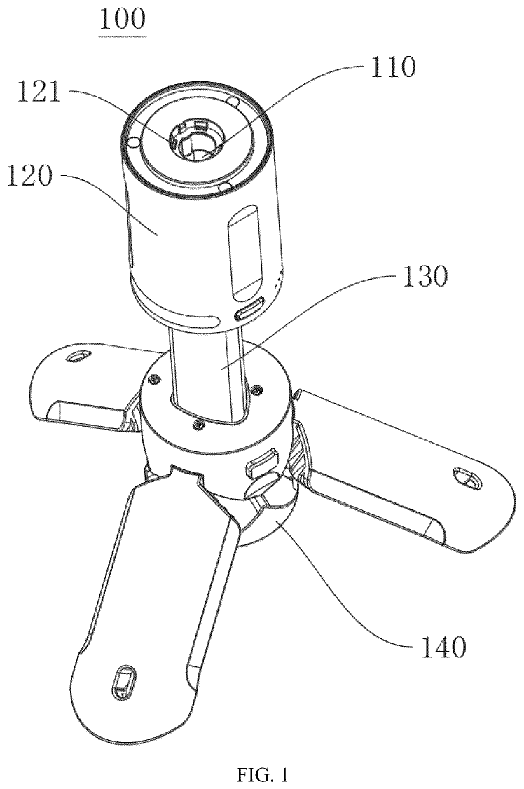

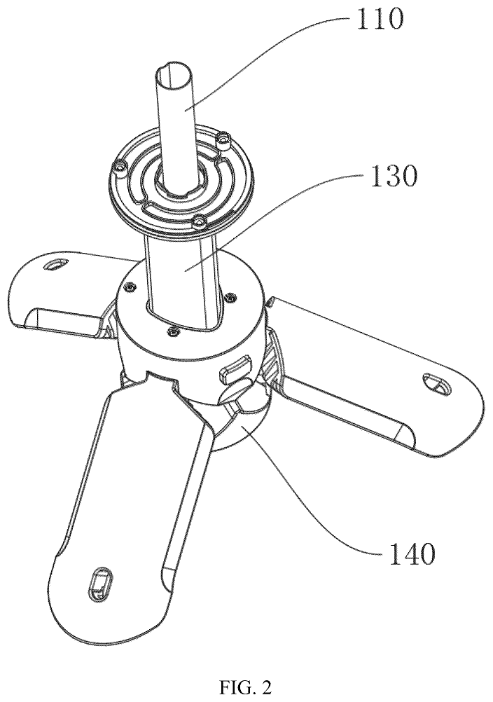

As shown in FIG. 1 and FIG. 2, this embodiment of the present disclosure provides a battery mounting structure 100, which is mainly applied to an outdoor mobile power supply 1000, and the outdoor mobile power supply 1000 is mainly applied to an electronic assembly 10000. The battery mounting structure 100 comprises a telescopic member 110, a first battery assembly 120 and at least one second battery assembly (not shown in the drawings).

The first battery assembly 120 is sleeved on the telescopic member 110, one second battery assembly is sleeved on the telescopic member 110 and electrically connected with the first battery assembly 120, and the remaining second battery assemblies are sleeved on the telescopic member 110 in an axial direction of the telescopic member 110 in sequence and electrically connected in sequence.

According to the battery mounting structure 100 provided in this embodiment of the present disclosure, by sleeving the first battery assembly 120 on the telescopic member 110, a function of stably mounting the first battery assembly 120 is realized. By sleeving one second battery assembly on the telescopic member 110 and electrically connecting the second battery assembly with the first battery assembly 120, and sleeving the remaining second battery assemblies on the telescopic member 110 in the axial direction of the telescopic member 110 in sequence and electrically connecting the second battery assemblies in sequence, a user can increase or reduce a number of the second battery assemblies at will according to an actual electricity demand, so as to increase or reduce a battery capacity at will, thus improving use convenience and portability. The technical problem of being inconvenient to use and carry caused by a fact that a number of internal batteries in most existing outdoor mobile power supplies is fixed, so that the user cannot increase or reduce a number of batteries at will according to an actual electricity demand in the prior art are avoided.

As shown in FIG. 1 and FIG. 2, in some embodiments of the present disclosure, the battery mounting structure 100 further comprises a supporting member 130, the first battery assembly 120 is arranged on the supporting member 130, and a part of the telescopic member 110 is located in an inner circumferential direction of the supporting member 130.

In this embodiment, by arranging the first battery assembly 120 on the supporting member 130, the first battery assembly 120 is supported, so as to realize a function of stably mounting the first battery assembly 120. By arranging one part of the telescopic member 110 in the inner circumferential direction of the supporting member 130, a function of stably mounting the telescopic member 110 is realized, so that the telescopic member 110 can extend out of the supporting member 130 or retract into the supporting member 130.

As shown in FIG. 1 and FIG. 2, in some embodiments of the present disclosure, optionally, the battery mounting structure 100 further comprises a base 140, and the supporting member 130 and the telescopic member 110 are both arranged on the base 140.

In this embodiment, by arranging both the supporting member 130 and the telescopic member 110 on the base 140, the functions of stably mounting the supporting member 130 and the telescopic member 110 are realized.

As shown in FIG. 1, in one embodiment of the present disclosure, optionally, one end of the first battery assembly 120 close to the second battery assembly is provided with a first conductive portion 121, one second battery assembly is sleeved on the telescopic member 110 and electrically connected with the first conductive portion 121, and the remaining second battery assemblies are sleeved on the telescopic member 110 in the axial direction of the telescopic member 110 in sequence and electrically connected in sequence.

In this embodiment, by arranging the first conductive portion 121 at one end of the first battery assembly 120 close to the second battery assembly, sleeving one second battery assembly on the telescopic member 110 and electrically connecting the second battery assembly with the first conductive portion 121, and sleeving the remaining second battery assemblies on the telescopic member 110 in the axial direction of the telescopic member 110 in sequence and electrically connecting the second battery assemblies in sequence, the user can increase or reduce a number of the second battery assemblies flexibly according to an actual electricity demand, so as to increase or reduce the battery capacity flexibly, thus improving use convenience and portability.

In the above embodiment of the present disclosure, optionally, the second battery assembly is provided with a second conductive portion and a third conductive portion, the second conductive portion and the third conductive portion are respectively arranged at two ends of the second battery assembly, a second conductive portion of one second battery assembly is electrically connected with the first conductive portion 121, and a third conductive portion of one second battery assembly is electrically connected with a second conductive portion of an adjacent second battery assembly.

In this embodiment, by respectively arranging the second conductive portion and the third conductive portion at two ends of the second battery assembly, electrically connecting the second conductive portion of one second battery assembly with the first conductive portion 121, and electrically connecting the third conductive portion of the second battery assembly with the second conductive portion of the adjacent second battery assembly, the first battery assembly 120 and the multiple second battery assemblies are electrically connected in series in sequence, thus expanding the battery capacity.

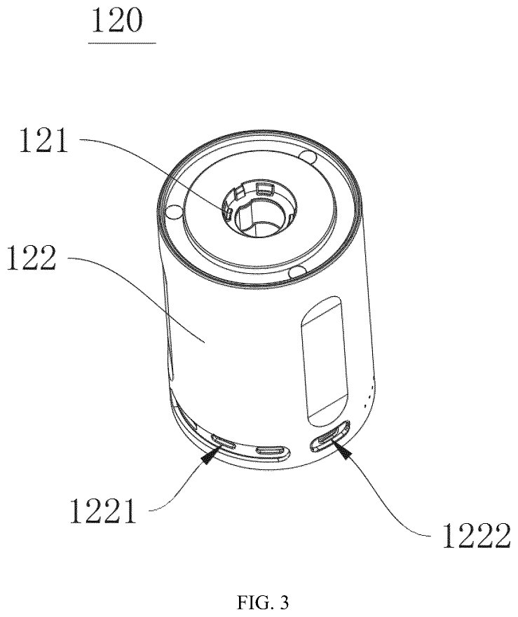

As shown in FIG. 3, in the above embodiment of the present disclosure, optionally, the first battery assembly 120 comprises a first shell 122, a first battery 123 and a circuit board 124, the first battery 123 and the circuit board 124 are both arranged in the first shell 122, and the first battery 123 is electrically connected with the circuit board 124 and the first conductive portion 121 respectively.

In this embodiment, by arranging both the first battery 123 and the circuit board 124 in the first shell 122, the first battery 123 and the circuit board 124 are protected, so as to avoid a short-circuit damage caused by rain when the first battery 123 and the circuit board 124 are used outdoors, thus prolonging a service life of a product. By electrically connecting the first battery 123 with the circuit board 124 and the first conductive portion 121 respectively, the first battery 123 is controlled to be charged and discharged through the circuit board 124, and electrically connected with the second battery assembly or other outdoor electrical devices through the first conductive portion 121.

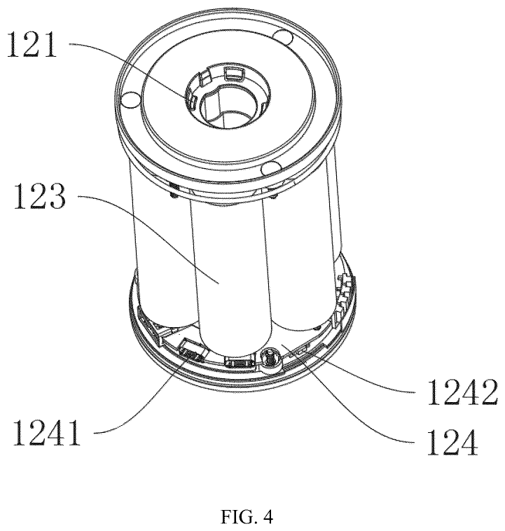

As shown in FIG. 3 and FIG. 4, in the above embodiment of the present disclosure, optionally, the circuit board 124 is provided with a charging interface 1241 and a power button 1242, and the first shell 122 is provided with a first avoidance port 1221 matched with the charging interface 1241 and a second avoidance port 1222 matched with the power button 1242.

In this embodiment, by arranging the charging interface 1241 on the circuit board 124, and arranging the first avoidance port 1221 matched with the charging interface 1241 on the first shell 122, the user can charge the first battery 123 and the second battery assembly by using a data cable matched with the charging interface 1241, or charge outdoor devices such as a mobile phone by using the first battery 123 and the second battery assembly.

By arranging the power button 1242 on the circuit board 124, and arranging the second avoidance port 1222 matched with the power button 1242 on the first shell 122, the user can turn on or off the first battery 123 and the second battery assembly by pressing the power button 1242.

In the above embodiment of the present disclosure, optionally, the second battery assembly comprises a second shell and a second battery, and the second battery is arranged in the second shell, and electrically connected with the second conductive portion and the third conductive portion respectively.

In this embodiment, by arranging the second battery in the second shell, the second battery is protected, so as to avoid a short-circuit damage caused by rain when the second battery is used outdoors, thus prolonging a service life of a product. By electrically connecting the second battery with the second conductive portion and the third conductive portion respectively, the first battery 123 and the multiple second batteries are electrically connected in series in sequence, thus expanding the battery capacity, and the second battery at a tail end can be electrically connected with other outdoor electrical devices through the third conductive portion.

### Second Embodiment

Second Embodiment in the present disclosure further provides an outdoor mobile power supply 1000, which comprises the battery mounting structure 100 in any one of the above embodiments.

The outdoor mobile power supply 1000 has the battery mounting structure 100 in First Embodiment, so that the outdoor mobile power supply has all the beneficial effects of the battery mounting structure 100 in First Embodiment, which will not be repeated herein.

### Third Embodiment

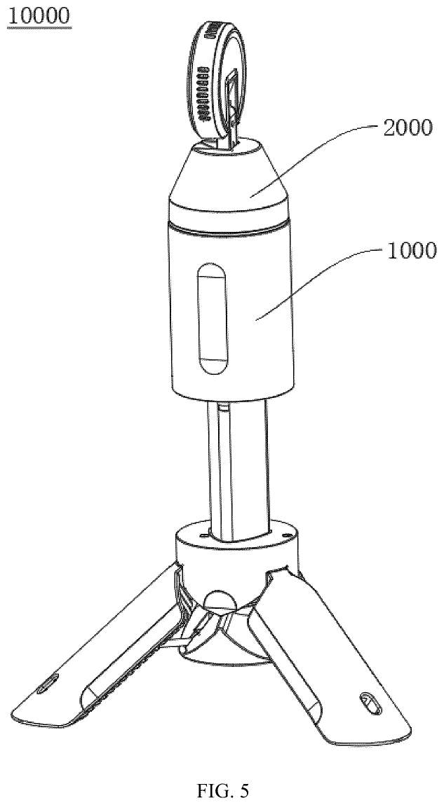

As shown in FIG. 5, Third Embodiment in the present disclosure further provides an electronic assembly 10000, which comprises an electronic device 2000 and the outdoor mobile power supply 1000 in Second Embodiment above.

The electronic device 2000 may be a camping lamp, a wireless charging device, a mosquito killer, and the like.

The electronic assembly 10000 has the outdoor mobile power supply 1000 in Second Embodiment, so that the electronic assembly has all the beneficial effects of the outdoor mobile power supply 1000 in Second Embodiment, which will not be repeated herein.

To sum up, the present disclosure provides the battery mounting structure 100, and the battery mounting structure 100 comprises the telescopic member 110, the first battery assembly 120 and the at least one second battery assembly. By sleeving the first battery assembly 120 on the telescopic member 110, a function of stably mounting the first battery assembly 120 is realized. By sleeving one second battery assembly on the telescopic member 110 and electrically connecting the second battery assembly with the first battery assembly 120, and sleeving the remaining second battery assemblies on the telescopic member 110 in the axial direction of the telescopic member 110 in sequence and electrically connecting the second battery assemblies in sequence, a user can increase or reduce a number of the second battery assemblies at will according to an actual electricity demand, so as to increase or reduce a battery capacity at will, thus improving use convenience and portability. The technical problem of being inconvenient to use and carry caused by a fact that a number of internal batteries in most existing outdoor mobile power supplies is fixed, so that the user cannot increase or reduce a number of batteries at will according to an actual electricity demand in the prior art are avoided.

In the descriptions of the specification, the descriptions with reference to the terms “one embodiment”, “some embodiments”, “example”, “specific example” or “some examples”, and the like refer to that specific features, structures, materials or characteristics described with reference to the embodiments or examples are included in at least one embodiment or example of the present disclosure. In the specification, the schematic representation of the above terms does not necessarily refer to the same embodiment or example. Moreover, the specific features, structures, materials or characteristics described may be combined in any one or more embodiments or examples in a suitable manner. In addition, in the case of having no mutual contradiction, those skilled in the art may join and combine different embodiments or examples described in the specification and the characteristics of the different embodiments or examples.

Although the embodiments of the present disclosure have been shown and described above, it may be understood that the above embodiments are exemplary and cannot be understood as limiting the present disclosure, and those of ordinary skills in the art may make changes, modifications, substitutions and variations to the above embodiments within the scope of the present disclosure.

### INDUSTRIAL APPLICABILITY

The present disclosure provides the battery mounting structure, and the battery mounting structure comprises the telescopic member, the first battery assembly and the at least one second battery assembly. By sleeving the first battery assembly on the telescopic member, a function of stably mounting the first battery assembly is realized. By sleeving one second battery assembly on the telescopic member and electrically connecting the second battery assembly with the first battery assembly, and sleeving the remaining second battery assemblies on the telescopic member in the axial direction of the telescopic member in sequence and electrically connecting the second battery assemblies in sequence, a user can increase or reduce a number of the second battery assemblies at will according to an actual electricity demand, so as to increase or reduce a battery capacity at will, thus improving use convenience and portability. The technical problem of being inconvenient to use and carry caused by a fact that a number of internal batteries in most existing outdoor mobile power supplies is fixed, so that the user cannot increase or reduce a number of batteries at will according to an actual electricity demand in the prior art are avoided.

Furthermore, it can be understood that the battery mounting structure provided by the present disclosure is reproducible and can be used in various industrial applications. For example, the battery mounting structure provided by the present disclosure may be used in the field of electronic assemblies.

We claim:

1. A battery mounting structure, comprising:
a telescopic member;
a first battery assembly, wherein the first battery assembly is sleeved on the telescopic member; and
at least one second battery assembly, wherein one second battery assembly is sleeved on the telescopic member and electrically connected with the first battery assembly, and the remaining second battery assemblies are sleeved on the telescopic member in an axial direction of the telescopic member in sequence and electrically connected in sequence.

2. The battery mounting structure according to claim 1, wherein the battery mounting structure further comprises a supporting member, the first battery assembly is arranged on the supporting member, and a part of the telescopic member is located in an inner circumferential direction of the supporting member.

3. The battery mounting structure according to claim 2, wherein the battery mounting structure further comprises a base, and the supporting member and the telescopic member are both arranged on the base.

4. The battery mounting structure according to claim 1, wherein one end of the first battery assembly close to the second battery assembly is provided with a first conductive portion, one second battery assembly is sleeved on the telescopic member and electrically connected with the first conductive portion, and the remaining second battery assemblies are sleeved on the telescopic member in the axial direction of the telescopic member in sequence and electrically connected in sequence.

5. The battery mounting structure according to claim 4, wherein the second battery assembly is provided with a second conductive portion and a third conductive portion, the second conductive portion and the third conductive portion are respectively arranged at two ends of the second battery assembly, a second conductive portion of one second battery assembly is electrically connected with the first conductive portion, and a third conductive portion of one second battery assembly is electrically connected with a second conductive portion of an adjacent second battery assembly.

6. The battery mounting structure according to claim 4, wherein the first battery assembly comprises a first shell, a first battery and a circuit board, the first battery and the circuit board are both arranged in the first shell, and the first battery is electrically connected with the circuit board and the first conductive portion respectively.

7. The battery mounting structure according to claim 6, wherein the circuit board is provided with a charging interface and a power button, and the first shell is provided with a first avoidance port matched with the charging interface and a second avoidance port matched with the power button.

8. The battery mounting structure according to claim 5, wherein the second battery assembly comprises a second shell and a second battery, and the second battery is arranged in the second shell, and electrically connected with the second conductive portion and the third conductive portion respectively.

9. An outdoor mobile power supply, comprising the battery mounting structure according to claim 1.

10. An electronic assembly, comprising an electronic device and the outdoor mobile power supply according to claim 9.
